(19) United States
(12) Patent Application Publication
(10) Pub. No.: US 2002/0002629 A1
(43) Pub. Date: Jan. 3, 2002

(54) METHOD AND SYSTEM FOR INTERFACING APPLICATION SOFTWARE WITH ELECTRONIC WRITEBOARD

(76) Inventor: TOM H FUKUSHIMA, CALGARY (CA)

Correspondence Address: FITZPATRICK CELLA HARPER & SCINTO, 30 ROCKEFELLER PLAZA, NEW YORK, NY, 10112, US

(21) Appl. No.: 08/962,039

(22) Filed: Oct. 31, 1997

(51) Int. Cl. G06F 9/00; G06F 9/54; G06F 15/163

(52) U.S. Cl. 709/310

(57) ABSTRACT

An interactive display system includes an electronic writeboard having a touch sensitive panel and a tool tray accommodating at least one tool selectable to apply pressure to the touch sensitive panel. Controller means is responsive to the touch sensitive panel and tool tray and generates events. A computer is connected to the electronic writeboard and executes applications software. An interface acts between the controller means and the applications software and translates events generated by the electronic writeboard into messages processable by the applications software.

### FIELD OF THE INVENTION

The present invention relates to electronic writeboards and in particular to a method and system for interfacing applications software executed by a host computer with an electronic writeboard.

### BACKGROUND OF THE INVENTION

Electronic writeboards (EWRs) are known in the art and have been used in conjunction with host computers executing applications software to provide enhanced multimedia and teleconferencing capabilities. An example of an electronic writeboard of this nature is sold by Smart Technologies Inc. of Calgary, Alberta, Canada under the name Smart Board. This electronic writeboard includes a touch sensitive panel and a tool tray accommodating a plurality of tools such as coloured pens and an eraser as well as an associated controller and driver. A software development kit (SDK) including source code and supporting documentation is provided with the electronic writeboard to allow a user to write client applications to enhance the functionality of the electronic writeboard.

In use, the electronic writeboard is connected to a host computer, such as a personal computer (PC), operating in a Windows environment and executing applications software, via a standard serial cable. The electronic writeboard can be operated in one of two modes, namely a projection mode and a non-projection mode.

In the projection mode, the image on the screen of the personal computer is projected onto the touch sensitive panel. In this case, the electronic writeboard functions as a giant mouse providing input to the personal computer in response to user input made by touching the touch sensitive panel. The applications software in the personal computer performs operations in accordance with the input received from the electronic writeboard. Thus, by pressing on the touch sensitive panel, the personal computer can be conditioned to open and display menus, to activate displayed menus, to drag icons and to execute software.

In the non-projection mode, no image is projected onto the touch sensitive panel. Instead, a dry erase marker is used to write on the touch sensitive panel. The applications software in the personal computer tracks where writing on the touch sensitive panel has occurred and maintains a computerized image of the touch sensitive panel. This allows meeting notes to be saved and/or printed.

When the electronic writeboard and the personal computer are connected and initialized, the electronic writeboard driver registers with the applications software executed by the personal computer. During the registration process, the driver determines the messages to which the applications software responds. Once the registration process has been completed, all events generated by the electronic writeboard are sent directly to the applications software.

In order for the applications software to register with the electronic writeboard, it must be “aware”. When the applications software is aware, it uses the SDK source code and has part of the SDK, namely a CSMARTBoardHandler class, embedded therein so that when an event is received from the driver, the applications software calls a “hook”. In this manner for example, when a tool is removed from the tool tray and used to write on the touch sensitive panel, the writing results in native pen stroke annotations being generated by the applications software.

In many cases however, third party applications software is not “aware” of the electronic writeboard due to the reluctance of third parties to embed parts of the SDK source code into their software. This is due to the fact that it may introduce hugs into their applications software and requires extra resources to implement and test their modified applications software. As a result, if a tool is lifted from the tool tray, the applications software will not get an event. Also, if the tool is used to write on the touch sensitive panel, the electronic writeboard driver creates temporary annotations instead of native pen stroke annotations being generated by the applications software. Accordingly, means to make applications software not specifically written for an electronic writeboard, “aware” of the electronic writeboard is desired.

It is therefore an object of the present invention to provide a novel system and method for interfacing applications software executed by a computer with an electronic writeboard.

### SUMMARY OF THE INVENTION

According to one aspect of the present invention there is provided a method of interfacing applications software with an electronic writeboard comprising the steps of:

maintaining a table of electronic writeboard events and associated applications software messages representing operations to be performed by said applications software in response to electronic writeboard events;

monitoring events generated by said electronic writeboard;

comparing each event generated by said electronic writeboard with electronic writeboard events in said table to determine if said generated event is in said table; and

transmitting the associated applications software message to said applications software for processing when said generated event is in said table.

According to another aspect of the present invention there is provided an interface for interfacing applications software with electronic writeboard comprising:

a table storing a list of electronic writeboard events and associated applications software messages;

means to monitor events generated by said electronic writeboard;

means to compare each event generated by said electronic writeboard with said list to determine if said generated event is in said table; and

means to transmit the associated applications software message to said applications software for processing when said generated event is in said table.

According to still yet another aspect of the present invention there is provided an interactive display system comprising:

an electronic writeboard including a touch sensitive panel, a tool tray accommodating at least one tool selectable to apply pressure to said touch sensitive panel and controller means responsive to said touch sensitive panel and tool tray and generating events;

a computer connected to said electronic writeboard and executing applications software; and

an interface acting between said controller means and said applications software and translating events generated by said electronic writeboard into messages processable by said applications software.

The present invention provides advantages in that third party applications software can be made “aware” of the electronic writeboard while only requiring minimal involvement of the third party. In addition, when an electronic writeboard tool is selected, the interface software automatically selects a corresponding tool, if one exists, in the applications software making the interface very natural and virtually seamless. Also, the interface software results in smoother and more legible figures and characters being projected onto the touch sensitive panel when the electronic writeboard is operating in a projection mode in response to pressure applied to the touch sensitive panel using a tool, as compared to characters and figures drawn using a mouse-based input device. Furthermore, the interface software ensures annotations generated by the electronic writeboard driver as a result of pressure applied to the touch sensitive panel using a tool are native to the applications software.

### BRIEF DESCRIPTION OF THE DRAWINGS

An embodiment of the present invention will now be described more fully with reference to the accompanying drawings in which:

FIG. 1 is schematic view of an interactive display system;

FIG. 2 is a functional block diagram of Aware interface software in accordance with the present invention used in the system of FIG. 1;

FIG. 3 is a flowchart illustrating the registration process between the interface software of the present invention and a driver in an electronic writeboard;

FIG. 4 is a flowchart illustrating the loop process performed by the interface software in order to handle electronic writeboard events;

FIG. 5 is table showing a list of electronic writeboard events and associated EWB applications software commands generated by the interface software for a personal computer executing Microsoft NetMeeting Whiteboard;

FIG. 6 is a flowchart illustrating the messages generated by the interface software and conveyed to the personal computer in response to a specific electronic writeboard event; and

FIG. 7 is a flowchart illustrating the steps performed by the interface software in response to electronic writeboard contact events when the electronic writeboard is operated in a non-projection mode.

### DETAILED DESCRIPTION OF THE PREFERRED EMBODIMENT

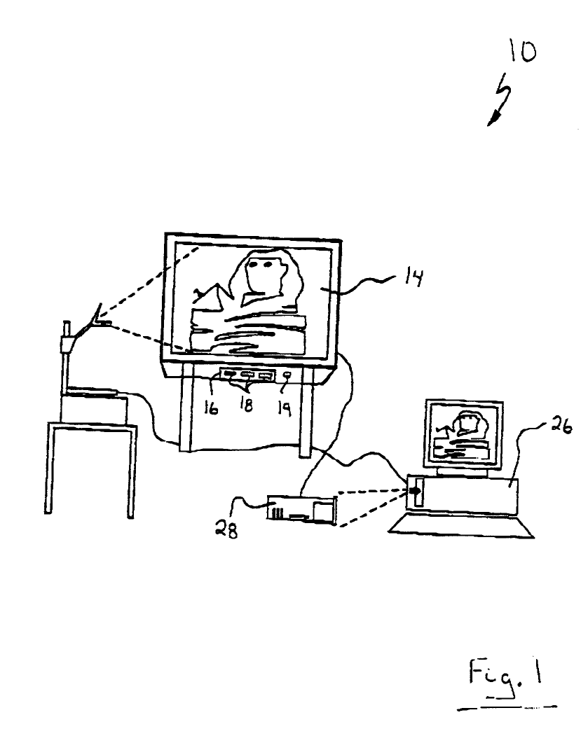

Referring now to FIG. 1, an interactive display system is shown and is generally indicated to by reference numeral 10. As can be seen, interactive display system 10 includes an electronic writeboard 12 (EWB) of the type manufactured by Smart Technologies Inc. under model No. SB360 and sold under the name Smart Board. The Smart Board 12 includes a touch sensitive panel 14 and a tool tray 16 accommodating a plurality of tools 18 and having at least one user selectable button 19. The tools 18 include a number of coloured pens and an eraser. A controller 28 having memory is installed in a slot of a personal computer 26 executing application software. The controller 28 executes a controller application to control the overall operation of the Smart Board 12. A driver in the form of an application is executed by the personal computer 26 and translates serial data from the controller 28 into events such as mouse events, tool change events and button press events. A software development kit (SDK) including source code and supporting documentation is provided with the Smart Board to allow a user to write client applications to enhance the functionality of the Smart Board 12. The SDK includes C++ source code for a CSMARTBoardHandler allowing Smart Board default behaviors to be overridden by writing client applications deriving classes from the CSMARTBoardHandler. Appendix A illustrates methods of the CSMARTBoardHandler.

The Smart Board 12 can operate either in a projection mode or in a non-projection mode. As mentioned previously, in the projection mode, images generated by the personal computer 26 are projected onto the touch sensitive panel 14 and the Smart Board 12 functions as a giant mouse. In the non-projection mode, no images are projected onto the touch sensitive panel 14. The touch sensitive panel is however mapped onto the drawing area of the applications software so that notes written on the touch sensitive panel 14 are stored by the personal computer 26.

The personal computer 26 operates in a Windows environment and in this particular embodiment, executes Microsoft NetMeeting Whiteboard applications software sold by Microsoft Corporation of Redmond. Wash. The Microsoft NetMeeting Whiteboard (MNW) applications software is “unaware” of the Smart Board 12. To make the MNW applications software “aware” of the Smart Board, Aware interface software is also executed by the personal computer 26. The Aware interface software translates events generated by the Smart Board driver into commands that can be understood and processed by the MNW applications software. Further details of the Aware interface software and the Smart Board SDK will now be described

The SDK includes source code that compiles under Visual C++ or Borland C++ and as mentioned above allows a user to write client applications. The controller application executed by the controller 28 has a well-defined external interface of which the client applications take advantage. The SDK wraps the controller interface in a C++ class thereby allowing a user to take advantage of the features of the Smart Board in an easy and natural way. The Smart Board driver uses the SDK to communicate with the Aware interface software.

When the Smart Board 12 is operating in the projection mode, the Smart Board driver generates events falling generally into three categories, namely button events, tool tray events, and contact events. Button events occur when one of the buttons 19 on the tool tray 16 is pressed. The controller application allows the user to select from a series of behaviors for this button. In the controller application, each button 19 is mapped to a specific behavior. When a button 19 is pressed, the SDK finds the specific behavior mapped to that button and calls a virtual handler for that behavior. Overriding the virtual handler via a client application gives a user the ability to alter the behavior for that button event.

Tool tray events occur when a pen or eraser is lifted from the tool tray 16. These events reflect the fact that a tool 18 has been selected. Subsequent contacts on the touch sensitive panel 14 are therefore interpreted as drawing events with that particular tool. The pens are configured through the controller application allowing the size and colour for a particular pen to be selected as desired.

Contact events are generated if highly precise writing is required. Because the Smart Board 12 functions as a mouse in the projection mode, intermediate move events may be lost if the interactive display system 10 is really busy. This is due to the fact that Windows only keeps one move event in the system queue, replacing it with an updated move event if the move event is not processed quickly enough. The result can be very choppy writing displayed on the screen of the personal computer 26 and projected onto the touch sensitive panel 14. By requesting contact events to be generated via a client application a parallel mechanism of contact down, move, and contact up events is coated. The pattern of contact events is almost exactly the same as it is for drawing events, except that WPARAM contains some additional information about the tool being used.

These contact events are posted to the MNW applications software queue and therefore, they are not discarded when new contact events are posted to the queue, allowing all of the points in a stroke to be maintained. However, doing this increases the processing drain on the MNW applications software and therefore, the easiest way to handle these contact events is to simply register the event Ids to be WM_LBUTTONDOWN. WM_MOUSEMOVE, and WM_LBUTTONUP. These pseudo mouse events can be handled by the MNW applications software without writing any extra code.

Because these contact events are not mouse events, the window in which the contact events are to be received must be specified. Contact events outside of the specified window are treated like mouse events, whereas contact events inside the window are treated as described above. This allows floating tool bars and palettes to be used, even when the surrounding surface captures mouse events.

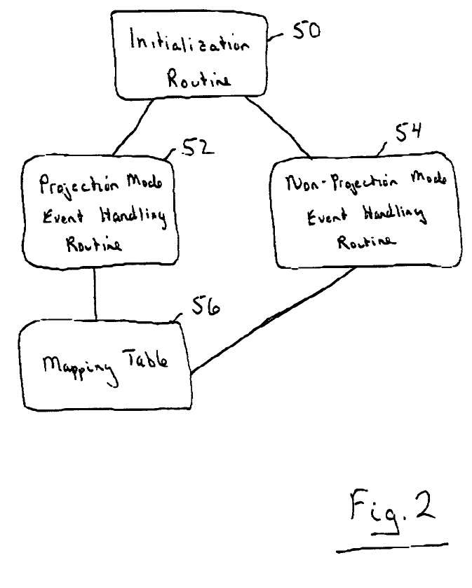

Referring now to FIG. 2, the functional blocks of the Aware interface software are shown. As can be seen, the Aware interface software includes an initialization routine 50, a projection mode event handling routine 52, a non-projection event handling routine 54 and a mapping table 56 accessed by the projection mode event handling routine 52 and the non-projection mode event handling routine 54. The initialization routine 50 registers the MNW applications software with the Smart Board driver and terminates the registration when the MNW applications software has been terminated. The projection mode event handling routine 52 translates Smart Board generated events to commands processable by the MNW applications software to effect the desired operation of the MNW applications software. The non-projection event handling routine 54 maps contact events generated by the Smart Board driver onto the drawing area of the MNW applications software.

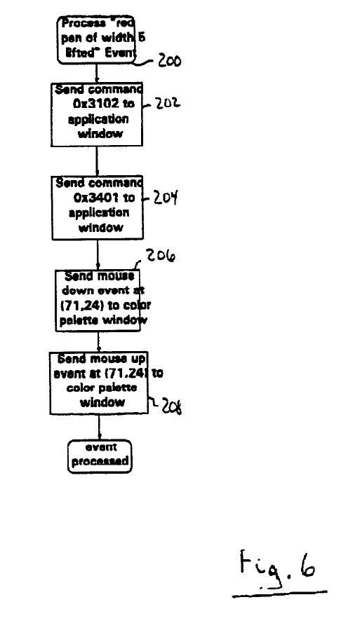

The mapping table 56 (shown in FIG. 5) includes a list of possible events that can be generated by the Smart Board driver and the corresponding effects the generated events are to have on the MNW applications software. The possible events are enumerated in the SDK documentation. Examples of such possible events are OnNewTool, OnPrint, On NextPage etc. Associated with each corresponding effect is a command or set of commands which cause the corresponding effect to take place in the MNW application software. The command or set of commands is sent by the Aware interface software to the personal computer 26 in response to the associated event received from the Smart Board driver to effect the MNW applications software operation. Where possible, the Aware interface software simulates the command by sending the command (ie. WM_COMMAND message) to the MNW applications software using a PostMessage API call directly to the MNW applications software. The commands are obtained from the applications software vendor or using a tool, such as for example Microsoft Spy++.

The mapping between the possible events and the corresponding effects the generated events are to have on the MNW applications software can be selected to suit desired needs. Therefore, the mapping does not need to be exact nor does the mapping need to reflect what is actually happening on the Smart Board 12. Also, generated events can be ignored by omitting them from the mapping table 56.

In some instances however, an MNW applications software command is not available and so the operation must be effected through a series of mouse actions. If the operations to be performed by the MNW applications software require the generation of messages having point parameters that are important, the values assigned to the point parameters are set to the center of the control being “clicked”. In this case, the messages will also require a handle to a window identifying the window getting the event. The Windows API call to find the handle of the correct Window is “FindWindow”.

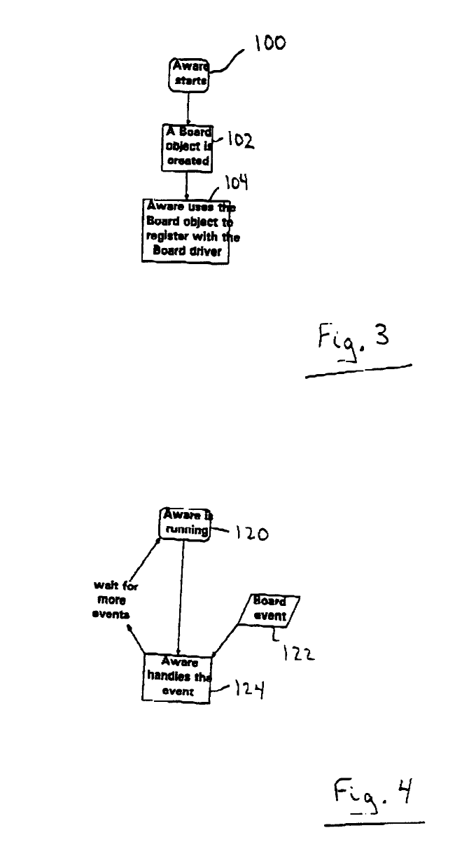

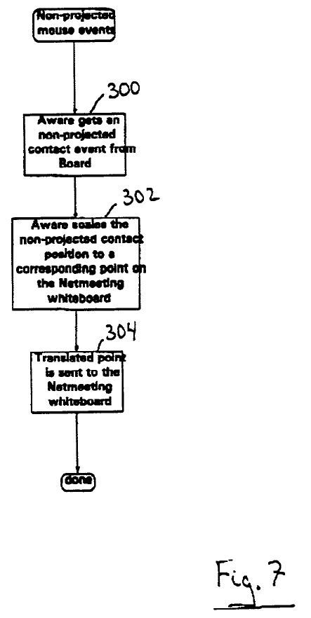

The operation of the Aware interface software will now be described with particular reference to FIGS. 3 to 7.

Initialization Routine

When the MNW applications software is executed by the personal computer 26, since the MNW applications software does not use the SDK of the Smart Board 12, no CSMARTBoardHandler object is created. The Aware interface software when started (block 100 in FIG. 3), enters its initialization routine 50. In the initialization routine, the Aware interface software checks to see if a CSMARTBoardHandler object is created for the NW applications software and if not creates one (block 102). This is achieved by initiating a timer and polling the windows in the operating software of the personal computer every 1000 ms using an EnumWindows API call. The Aware interface software then checks the list of windows to detect if a recognized application that has not been registered, is found. If this occurs, the Aware interface software creates a CSMARTBoardHandler object for the MNW applications software and the window is registered (block 104).

Once the CSMARTBoardHandler object is created by the Aware interface software, the Aware interface software uses the CSMARTBoardHandler object to register the MNW applications software with the Smart Board driver for one or both of the projection mode and non-projection mode depending on the call made by the MNW applications software. The registration process is performed using the CSMARTBoardHandler::RegisterRawContactWindow method. In particular, a CSMARTBoardHandler class (or some class derived from the CSMARTBoardHandler) is created in the Aware interface software and the RegisterRawContactWindow method is used to register the MNW applications software with the Smart Board driver.

The projection mode method call is as follows: RegisterRawContactWindow(canvasHWND, . . . , . . . , . . . , . . . ). The canvasHWND is the handle of the MNW applications software window that displays the pen strokes and other graphics. Once this method call is made, the Smart Board driver sends mouse events (i.e., WM_LBUTTONDOWN, WM_LBUTTON UP, and WM_MOUSEMOVE) to the Aware interface software which in turn passes the mouse events unchanged directly to the MNW applications software window specified by canvasHWND using a PostMessage API call, instead of through the system queue using a mouse_event API call.

During registration of the MNW application software to the Smart Board driver in the non-projection mode, the Aware interface software calls a non-projection mode constructor with appropriate parameters from the SDK. When the Smart Board 12 is operating in the non-projection mode, Smart Board events are not sent as mouse events. Since there is no projector, driving applications software without visual feedback is difficult.

The Aware interface software also checks the list of windows using the EnumWindows API call to detect if an application has been terminated. If an application that is currently registered with the Smart Board driver is no longer in the list of windows, it is deregistered from the Smart Board driver using the DeregisterRawContactWindow method of the CSMARTBoardHandler and the corresponding CSMARTBoardHandler object is destroyed.

Projection Mode Event Handling Routine

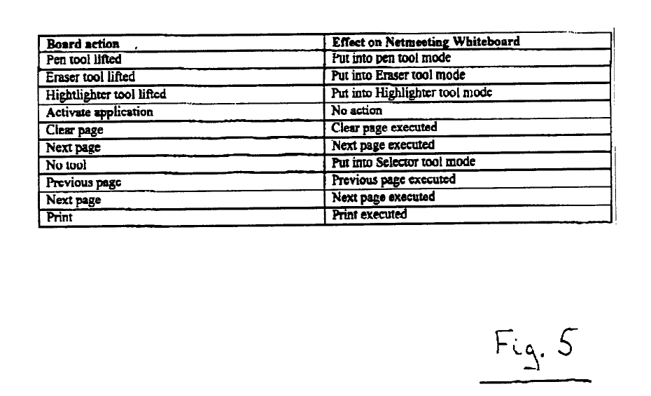

After the registration has been completed, the Aware interface software is ready to handle events generated by the Smart Board driver (block 120 in FIG. 4). If the Smart Board 12 is operating in the projection mode and an event is generated by the Smart Board driver (block 122), the CSMARTBoardHandler class is subclassed by the Aware interface software and the method corresponding to the event in the CSMARTBoardHandler is overridden. For example, if a new tool event is generated by the Smart Board driver due to the fact that a pen has been removed from the tool tray 16, the OnNewTool method in the CSMARTBoardHandler is overridden by the Aware interface software. Since the Aware interface software handles all Smart Board events it creates an instance of a subclass of the CSMARTBoardHandler where all hook methods have been overridden.

If the generated event is in the mapping table 56, the Aware interface software handles the event (block 124) by passing the command or set of commands associated with that event to the MNW applications software to effect the desired operation of the MNW applications software. Thus, if a tool is lifted from the tool tray 16, the Aware interface software sends a command to the MNW applications software to select a pen tool of a certain color and width. If a button has to be pressed in order for the MNW applications software to select the pen tool, a WM_LBUTTONDOWN and WM_LBUTTONUP message sequence is sent to the MNW applications software, setting point parameters, if important, and identifying the window getting the event.

For example, if a red pen tool of width five is selected from the tool tray 16 of the Smart Board 12, the Aware interface software first gets a call to the hook method OnNewTool (block 200 in FIG. 5). The Aware interface software then queries the Smart Board object to find out that it is a red pen of width five. The Aware interface software then compares the event with the mapping table 56 to determine what commands need to be sent to the MNW applications software in order for the MNW applications software to select a red pen of width 5. In order for the red pen of width 5 to be selected by the MNW applications software, the Aware interface software performs the following actions. Firstly, the Aware interface software sends a WM_COMMAND message with argument 0×3102 to the MNW applications software application window (block 202). A WM_COMMAND message with argument 0×3401 is then sent to the MNW applications software application window to select the pen line thickness most closely corresponding to a pen width of 5 (block 204). Following this, the Aware interface software sends mouse down and mouse up messages to the color palette window (class name has prefix: Afx:40000:3: title unimportant) at position (71,24) which is about the center of the red blotch in the color palette (blocks 206 and 208).

Mouse events generated by the Smart Board driver that are received by the Aware interface software are sent directly to the MNW applications software, bypassing the system event queue. Also, the registered application window(s) of the MNW applications software will receive contact events as mouse events directly from the Aware interface software, instead of through the system queue.

The reason for bypassing the system event queue is that the system event queue for WM_MOUSEMOVE events only holds one WM_MOUSEMOVE event at a time and may discard some of WM_MOUSEMOVE events if the MNW applications software takes too long to process them. This may result in some lost points. In this case, writing displayed un the touch sensitive panel 14 will not accurately reflect the pen strokes. By sending the WM_MOUSEMOVE events directly to the MNW applications software message queue using the PostMessage API call, the WM_MOUSEMOVE messages are not lost, unless the message queue overflows, and therefore the set of points will accurately reflect the pen stroke.

Non-Projection Event Handling Routine

In non-projection mode, pen strokes made on the touch sensitive panel 14 of the Smart Board 12 must be scaled to fit into the drawing area of the MNW applications software. A method call to the RegisterRawContactWindow method of the CSMARTBoardHandler registers the Aware interface software to handle the contact events generated by the Smart Board driver. The method is as follows: RegisterRawContactWindow(. . . , WM_USER+1, WM_USER+2, WM_USER+3, AwareWindowHWND). The second to fourth parameters specify when contact, move and release events occur, respectively. The final parameter of the method call specifies which window of the Aware interface software will receive these contact events.

When a contact event occurs, the Smart Board driver sends the event to the Aware interface software (block 300). Since all of the contact event points are in a space of approximately 4000 by 4000, the contact event points are translated to the current resolution of the drawing area of the MNW applications software by the Aware interface software (block 302) before the contact event points are sent to the MNW applications software (block 304).

For example, if the Aware interface software receives a WM_USER+2 message from the Smart Board driver with position argument (2000,2000), a WM_MOUSEMOVE message with position argument (200,100) is sent to the MNW applications software by the Aware interface software assuming the drawing area of the MNW applications software has a 400 by 200 dimension.

In the non-projection mode, it is desired that the pen strokes appearing in the MNW applications software closely reflect the pen strokes made on the touch sensitive panel 14 of the Smart Board 12. The eraser tool tends to cause problems due to the fact that MNW applications software includes an object eraser which causes entire objects to be deleted if touched with the object eraser. However, with a real eraser, only the part of the object that is actually touched by the eraser is erased.

To simulate this, the Aware interface software in response to eraser contact event sends messages to the MNW applications software to draw a thick white line. Thus, the part of the object that is being overwritten with the white line appears to disappear creating the eraser effect. If the applications software does not leave a pen tool that can draw a white line thick enough, the white line is simulated by drawing several parallel white lines close together, thus producing a white line of the desired thickness.

Although the Aware interface software has been described in conjunction with Microsoft NetMeeting Whiteboard applications software, it should be appreciated by those of skill in the art that the Aware interface software can be used with other third-party applications software. In this case, the commands associated with the mapping table will be set to achieve the desired operation in the projection mode. Also, in the non-projection mode the scaling factor will need to be set so that pen strokes made on the touch sensitive panel will be properly scaled onto the drawing area of the third-party applications software.

Although a preferred embodiment of the present invention has been described, those of skill in the art will appreciate that modifications and variations may be made without departing from the spirit and scope thereof as defined by the appended claims.

We claim:

1. A method of interfacing applications software with an electronic writeboard comprising the steps of:
maintaining a table of electronic writeboard events and associated applications software messages representing commands to be processed by said applications software in response to electronic writeboard events;
monitoring events generated by said electronic writeboard;
comparing each event generated by said electronic writeboard with electronic writeboard events in said table to determine if said generated event is in said table; and
transmitting the associated applications software message to said applications software for processing when said generated event is in said table.

2. The method of claim 1 wherein generated events not found in said table are ignored.

3. The method of claim 1 wherein for at least one of said events, said command is sent to said applications software using a PostMessage API call directly to said applications software.

4. The method of claim 1 wherein for at least one of said events, said set of commands represents mouse actions.

5. The method of claim 4 wherein said set of commands representing mouse actions includes point parameters set generally to the center of the control being selected and includes a handle identifying a window to receive the set of commands.

6. The method of claim 1 wherein mouse events generating by said electronic writeboard are set directly to said applications software and stored in an applications queue therein.

7. An interface for interfacing applications software with an electronic writeboard comprising:
a table storing a list of electronic writeboard events and associated applications software messages;
means to monitor events generated by said electronic writeboard;
means to compare each event generated by said electronic writeboard with said list to determine if said generated event is in said table; and
means to transmit the associated applications software message to said applications software for processing when said generated event is in said table.

8. An interactive display system comprising:
an electronic writeboard including a touch sensitive panel, a tool tray accommodating at least one tool selectable to apply pressure to said touch sensitive panel and controller means responsive to said touch sensitive panel and tool tray and generating events;
a computer connected to said electronic writeboard and executing applications software; and
an interface acting between said controller means and said applications software and translating events generated by said electronic writeboard into messages processable by said applications software.
